(19) United States
(12) Patent Application Publication
(10) Pub. No.: US 2009/0055374 A1
(43) Pub. Date: Feb. 26, 2009

(54) METHOD AND APPARATUS FOR GENERATING SEARCH KEYS BASED ON PROFILE INFORMATION

(75) Inventors: Luke Surazski, San Jose, CA (US); John A. Toebes, Cary, NC (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: CISCO TECHNOLOGY, INC., San Jose, CA (US)

(21) Appl. No.: 11/841,405

(22) Filed: Aug. 20, 2007

(51) Int. Cl. G06F 17/30

(52) U.S. Cl. 707/5; 707/E17.108

(57) ABSTRACT

Methods and apparatus for performing a search using a search keyword and associated aliases for the search keyword are disclosed. According to one aspect of the present invention, a method includes obtaining a search keyword via a user interface, and obtaining a search keyword via a user interface and automatically determining if there is at least one alias for the search keyword by searching a first database using the search keyword. The first database is a profile database that is configured to include a plurality of profiles that contain contact information, including a first profile that contains the search keyword. The method also includes automatically searching for at least one document using the alias if there is one, and the search keyword. The document is associated with a document data source.

### BACKGROUND OF THE INVENTION

The present invention relates generally to search engines. More particularly, the present invention relates to allowing search engines to perform searches using a set of keywords or search keys derived from a profile associated with an original keyword.

Search engines are software applications or programs that enable a user to search for and to retrieve information from databases, as for example databases on the World Wide Web. A search engine generally searches a database for documents which contain specified search keywords, and returns a list of the documents which contain the specified search keywords. Upon generating results for a specified search a search engine may present users a list of synonyms for the search term which could be used to generate related search results. These synonyms typically come from a language dictionary.

While search engines are effective in performing searches based on specific keywords and presenting equivalent synonyms based on a language dictionary there are cases, particularly in the field of communications, when a synonym dictionary for equivalent terms is not immediately available. By way of example, if a user initiates a search for references to an individual identified by the search keywords “John Doe,” only documents which include the search keywords “John Doe” will be retrieved by a search engine. A synonym search in a typical English language dictionary will not yield additional relevant search terms. If the search keywords “John Doe” have an associated equivalent such as an e-mail address or a phone number, documents which only specify the associated equivalent are not retrieved by a search engine. That is, a document which contains only an associated equivalent, e.g., an e-mail address or a phone number, for an individual named John Doe is generally not retrieved when a search using search keywords “John Doe” is performed. As a result, a user is effectively not provided with all documents that may be considered to be associated with search keywords “John Doe,” since John Doe may be referred to only by an associated equivalent in some documents. Hence, a search may not be comprehensive, and the user may not be presented with a relatively complete set of documents that are associated with John Doe.

Therefore, in the field of communications and identity management, what is needed is a system which allows a search engine to dynamically build an identity synonym dictionary and perform a search that encompasses both a search keyword and its associated equivalents. That is, what is desired is a method and an apparatus that enables keyword searches to be expanded to include all forms of identity searching on both a keyword and aliases for the keyword such that a relatively comprehensive search may be achieved.

### BRIEF DESCRIPTION OF THE DRAWINGS

The invention may best be understood by reference to the following description taken in conjunction with the accompanying drawings in which:

FIG. 1 is a block diagram representation of a system in which a search engine has access to alias information stored in a profile database in accordance with an embodiment of the present invention.

FIG. 2 is a block diagram representation of a search engine that is in communication with a profile database through an alias interface in accordance with an embodiment of the present invention.

FIG. 3A is a diagrammatic representation of data structures that store profile or contact metadata, e.g., data structures 240′ of FIG. 2, in accordance with an embodiment of the present invention.

FIG. 3B is a diagrammatic representation of a data structure that stores keywords or aliases and index numbers, i.e., table 303 of FIG. 3A, in accordance with an embodiment of the present invention.

FIG. 3C is a diagrammatic representation of a data structure that stores index numbers and document identifiers, i.e., table 305 of FIG. 3A, in accordance with an embodiment of the present invention.

FIG. 4 is a process flow diagram which illustrates steps associated with performing a keyword search using static data structures that store alias information in accordance with an embodiment of the present invention.

FIG. 5A is a diagrammatic representation of a system in which a search engine utilizes an alias interface to dynamically obtain alias information associated with a search keyword in accordance with an embodiment of the present invention.

FIG. 5B is a diagrammatic representation of a search engine that obtains a list of aliases for an input search keyword, e.g., search engine 504 of FIG. 5A, in accordance with an embodiment of the present invention.

FIG. 6 is a process flow diagram which illustrates one method of performing a search using a search engine that dynamically obtains alias information associated with a search keyword in accordance with an embodiment of the present invention.

FIG. 7 is a process flow diagram which illustrates one method of identifying aliases in a profile database, i.e., step 612 of FIG. 6, in accordance with an embodiment of the present invention.

FIG. 8 is a process flow diagram which illustrates one method of generating contact metadata in accordance with an embodiment of the present invention.

### DESCRIPTION OF THE EXAMPLE EMBODIMENTS

### General Overview

According to one aspect of the present invention, a method includes obtaining a search keyword via a user interface, and obtaining a search keyword via a user interface and automatically determining if there is at least one alias for the search keyword by searching a first database using the search keyword. The first database is a profile database that is configured to include a plurality of profiles that contain contact information, including a first profile that contains the search keyword. The method also includes automatically searching for at least one document using the alias if there is one, and the search keyword. The document is associated with a document data source.

### Description

Allowing synonyms or keyword equivalents to be automatically created for a search keyword associated with an identity provided to a search engine allows a search to be more comprehensive. If keyword equivalents are generated such that providing one piece of contact information for an entity results in substantially all contact information for the entity automatically being used for a search, results of the search are generally relatively complete.

Contact information, in one embodiment, may be information that is associated with an individual or an entity. In general, contact information is information that may be used to contact an individual or entity. By way of example, a given individual may have contact information including, but not limited to, a name, an e-mail address, and a phone number. If one piece of contact information associated with the individual is specified as a search keyword to a search engine, substantially all contact information associated with the individual may be automatically obtained by the search engine obtained prior to a search of a data source. As a result, the search keyword and substantially all aliases, or keyword equivalents, for the search keyword may be used to perform a search for documents associated with a data source.

Adding a mechanism to a search engine that generates, e.g., dynamically generates, a keyword list which establishes a mapping of a user query string or search keywords allows the scope of user queries to be enhanced. Documents may be matched to an entity regardless of which contact information is actually provided as a query string or a search keyword. As a result, a user of a search engine may search for documents associated with a contact using any contact information for the contact, and obtain the same documents.

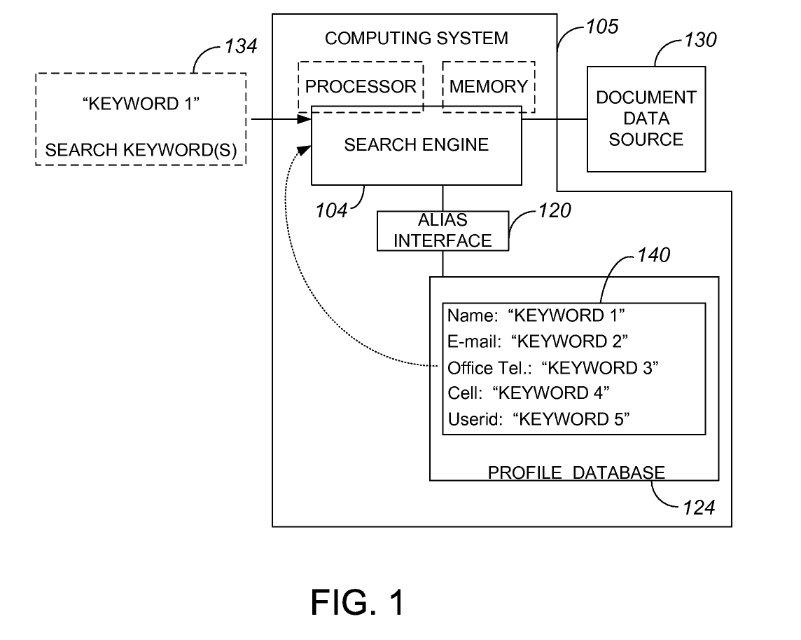

Typically, contact information is stored in a profile database that is substantially separate from a data source that is effectively being searched by a search engine. An alias interface may be used to facilitate access to the profile database by the search engine such that the search engine may obtain aliases for search keywords. FIG. 1 is a block diagram representation of a system in which a search engine has access to alias information stored in a profile database in accordance with an embodiment of the present invention. A search engine 104 is arranged to receive a search keyword or keywords 134. That is, search engine 104 is arranged to receive a query string that may include one or more keywords that are to be used to search for documents in a document data source 130, which is typically an external data source. Search engine 104 is generally a part of a computing system 105, and may be implemented as a program that executes on computing system 105.

Search engine 104 obtains search keyword 134, and through an alias interface 120, accesses a profile database 124 that contains at least one profile 140 or record. Using search keyword 134, profile 140 is searched for aliases by search engine 104 using alias interface 120. In the described embodiment, alias interface 120 is a separate component from search engine 104, although alias interface 120 may instead be included in search engine 104. Alias interface 120 includes code devices or logic that allows search engine 104 to effectively access profile database 124. Examples of such an interface include, but are not limited to including, SQL queries to an external database or a hard coded table of alias strings which may be preloaded into the search engine when it starts up. Alias interface 120 may also be a database query language that allows an external entity such as search engine 104 to extract all records from profile database 124. Alias interface 120 may, for instance, be the lightweight directory access protocol (LDAP). Alias interface 120 generally also implement logic to differentiate profile information which effectively constitutes an alias from profile information which does not effectively constitute an alias. For instance, a profile may contain a user's name and e-mail address, which are aliases. However, the profile may also contain the street address off the user's office, which may not be an alias for the user, as there may be multiple employees at that address. In substantially any method, alias interface 120 allows for identifying zero or more equivalent strings for any given keyword

Profile database 124 may be a database that contains contact information associated with an organization. By way of example, profile database may be a LDAP database that contains profiles for employees of a company. Each profile stored in a profile database may contain information that identifies a particular employee, i.e., there is typically one profile stored for each employee. It should be appreciated, however, that profiles stored in profile database 124 such as profile 140 are not limited to being associated with employees of a company. Profile 140 may generally be associated with a member of an organization, or may be associated with substantially any entity. By way of example, profile database 124 may be a database that contains information associated with schools in a particular area, and profile 140 may include contact information for a school. Profile 140 may also be represented as a personal address book stored either on an individual's personal device that is accessible through the network or even a centrally stored address book.

Profile database 124 is not limited to a single collection of contact information. As is common with modern contact management applications, profile database 124 may actually be a logical collection of multiple databases including, but not limited to including, a corporate database, shared address book, and personal address books.

Aliases are generally alternate keywords which identify the same entity, e.g., contact, as identified by search keyword 134. By way of example, search keyword 134 may be the name of a contact, and aliases associated with the name of the contact may include an e-mail address of the contact, telephone numbers of the contact, and a user identifier (userid) of the contact that are stored in profile 140.

Using search keyword 134 as well as aliases for search keyword 134, search engine 104 may effectively search data source 130 for documents which contain at least one alias or search keyword 134. For performance reasons, searching data source 130 may involve searching a metadata repository (not shown) in search engine 104 for metadata that is associated with documents in database 130. Documents in data source 130 may include a wide variety of document types. By way of example, documents may include hypertext markup language (HTML) documents, portable document format (PDF) documents, and web pages. It should be appreciated that, in one embodiment, a document may also be a media file, e.g., an audio file or a visual file. That is, searching data source 130 may generally involve a multi-media search.

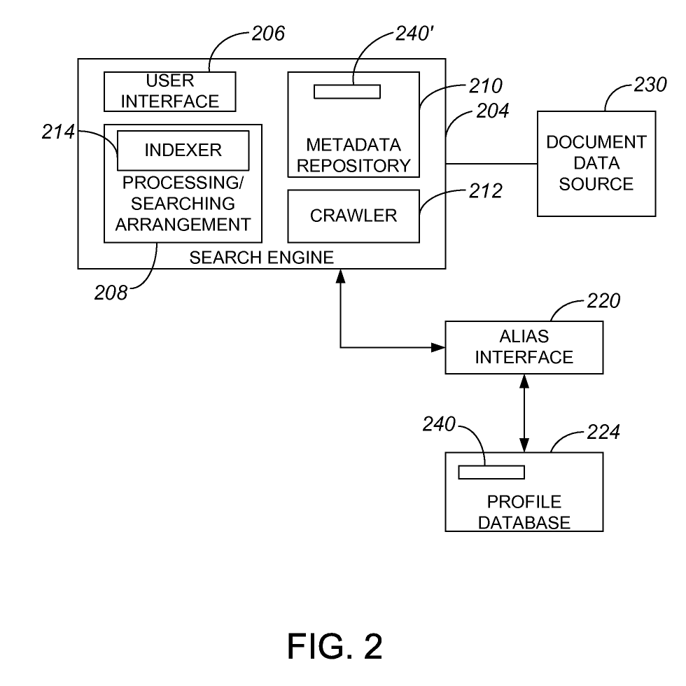

In general, components of a search engine may vary widely. With reference to FIG. 2, one search engine which may access a profile database through an alias interface will be described in accordance with an embodiment of the present invention. A search engine 204 accesses a profile database 224 through an alias interface 220 to obtain alias information from a profile 240 or a record. The alias information may then be used by search engine 204 to essentially search a document data source 230 for documents that contain the alias information or the search keyword, or both.

Search engine 204 includes a user interface 206 that enables a user, e.g., a requester of a search, to input a search keyword into search engine 204. User interface 206 may be a graphical user interface which allows a user to enter a search keyword into a web page of a browser displayed on a computing system (not shown) associated with the user.

A processing/searching arrangement 208 of search engine 204 provide functionality for retrieving a list of documents from a metadata repository or metadata database 210 that is associated with a search keyword provided through user interface 206. Processing/searching arrangement 208 generally implements a search algorithm or query processor that allows a search to be performed, and a ranking algorithm that allows results of the search to be ranked. Processing/searching arrangement 208 also implements an indexer 214 that indexes documents associated with document data source 230 and stored information associated with the documents as metadata into metadata repository 210. A web crawler 212 of search engine 204 searches through documents, e.g., web pages or other documents, stored in document data source 230, and collects information that may be used by indexer 214 to index the documents and to store metadata into metadata repository 210.

Alias interface 220 may be used in either a dynamic manner or a static manner. When used in a dynamic manner, each time a search keyword is entered using user interface 206, search engine 204 accesses profile database 224 through alias interface 220 to obtain aliases 240. When used in a static manner, aliases 240 are obtained through alias interface 220 and stored in metadata repository 210 such that when a search keyword is entered using user interface, aliases may be obtained without accessing profile database 224. In one embodiment, when alias interface 220 is used in a substantially static manner, alias interface 220 is arranged to enable a system administrator to enter a query regarding a search keyword that returns aliases or contact information 240 obtained from profile database 224. Aliases 240 obtained from profile database 224 may be stored as alias information in a data structure arrangement 240′ in a metadata repository 210 of search engine 204. Hence, when a user enters a search keyword through user interface 206, processing/searching arrangement 208 may access data structure arrangement 240′ to obtain the alias information, then subsequently use the search keyword and the alias information to identify documents in document data source 230.

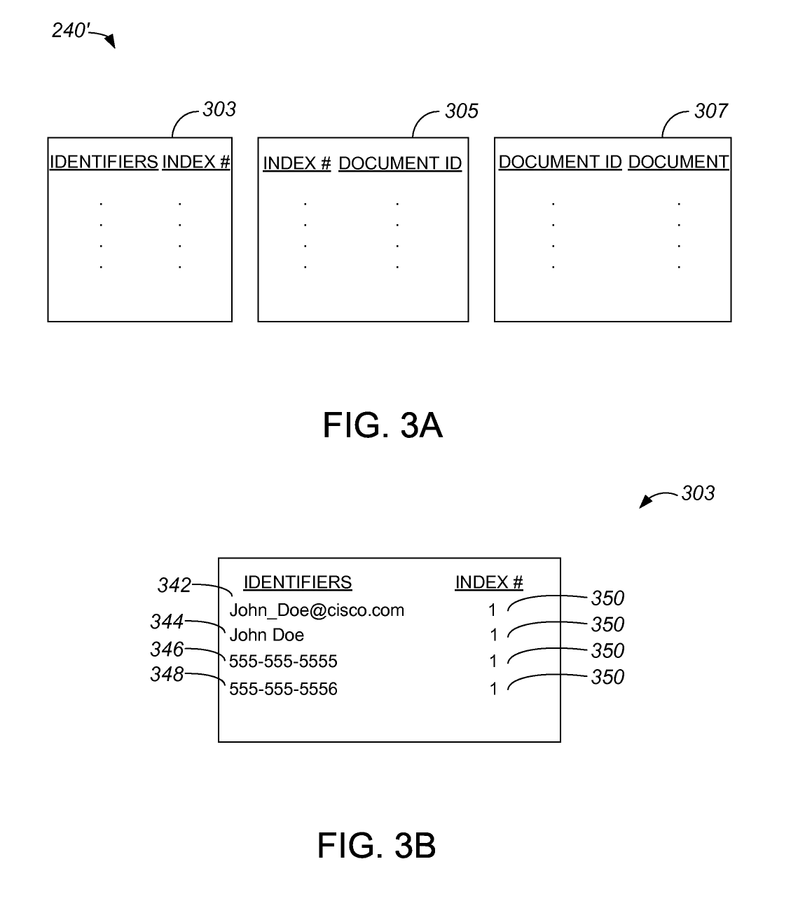

Data structure arrangement 240′ may include a plurality of tables that effectively associate alias information with documents that include the alias information. FIG. 3A is a diagrammatic representation of data structure arrangement 240′ in accordance with an embodiment of the present invention. Data structure arrangement 240′ includes a first table 303 that associates identifiers, e.g., keywords and aliases, with an index number that identifies certain identifiers as being associated with each other. That is, table 303 effectively groups together keywords which identify the same entity. As shown in FIG. 3B, identifiers that identify an individual named “John Doe” are associated with an index number ‘1’ 350. Identifiers include an e-mail address “John_Doe@cisco.com” 342, a name “John Doe” 344, a phone number “555-555-5555” 346, and a cell phone number “555-555-5556” 348. Each identifier may serve as a search keyword associated with “John Doe,” and each identifier may serve as an alias for any other search keyword associated with “John Doe.” By way of example, if cell phone number “555-555-5556” 348 is used as a search keyword, all other identifiers identified by index ‘1’ 350 are effectively aliases for the search keyword.

Returning to FIG. 3A, data structure arrangement 240′ also includes a table 305 that associates index numbers with identifiers for documents that include one or more keywords associated with an index number. FIG. 3C is a diagrammatic representation of table 305 in accordance with an embodiment of the present invention. Table 305 includes an index column and a document identifier (ID) column. The index column identifies index number ‘1’ 350 as being associated with document ID ‘A’ 352a, document ID ‘B’ 352b, and document ID ‘C’ 352c. Hence, an entity associated with keywords assigned to index number ‘1’ 350 is effectively identified in table 305 as being included or otherwise identified in document ID ‘A’ 352a, document ID ‘B’ 352b, and document ID ‘C’ 352c.

As shown in FIG. 3A, data structure arrangement 240′ also includes a table 307 that associates document IDs with actual documents. Table 307 may list document IDs, and names of documents which correspond to the document IDs. It should be appreciated that the names of documents may generally include links to documents stored in a document data source. That is, names of documents may identify actual locations of documents.

Data structure arrangement 240′ may be a static data structure arrangement, as data structure arrangement 240′ is generally not populated or updated as the result of a search. In other words, when a search keyword is entered into a search engine to effectively initiate a search, data structure arrangement 240′ is generally not altered as a result of an initiated search. It should be appreciated, however, that a static data structure arrangement may be updated substantially each time a search engine performs crawling or indexing.

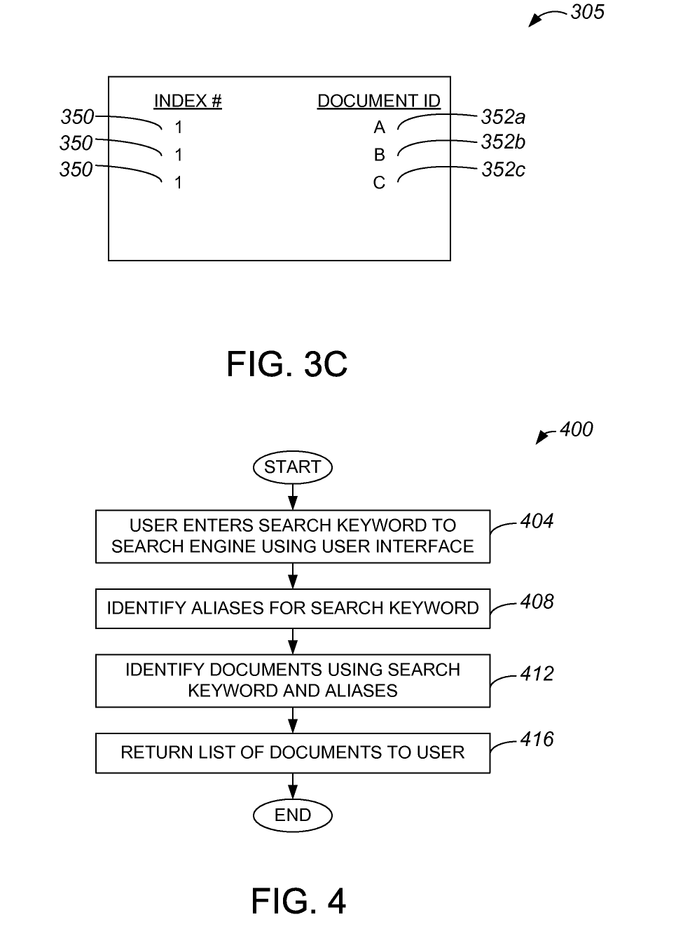

FIG. 4 is a process flow diagram which illustrates steps associated with performing a keyword search using a static data structure arrangement that stores alias information in accordance with an embodiment of the present invention. A process 400 of performing a keyword search begins at step 404 in which a search keyword is entered into a search engine through a user interface. Using the search keyword, the search engine identifies keyword equivalents, or aliases, for the search keyword in step 408. In the described embodiment, aliases are identified using a data structure arrangement stored in a metadata repository, e.g., data structure arrangement 240′ of FIGS. 3A-3C. As previously discussed, the data structure arrangement typically contains information obtained from a profile database.

After aliases for the search keyword are identified, a search is performed using the aliases and the search keyword in step 412. The search is performed to identify documents which contain either at least one alias or the search keyword, or both. Information that identifies documents stored in an external document data source is available in the data structure arrangement in which aliases are stored. Once the documents are identified, a list of the documents is returned to a user in step 416. Returning the list of documents may include displaying a list of selectable links to documents that contain at least one alias or the search keyword. The process of performing a keyword search is completed when the list of documents or, more generally, a list of search results is provided to the user.

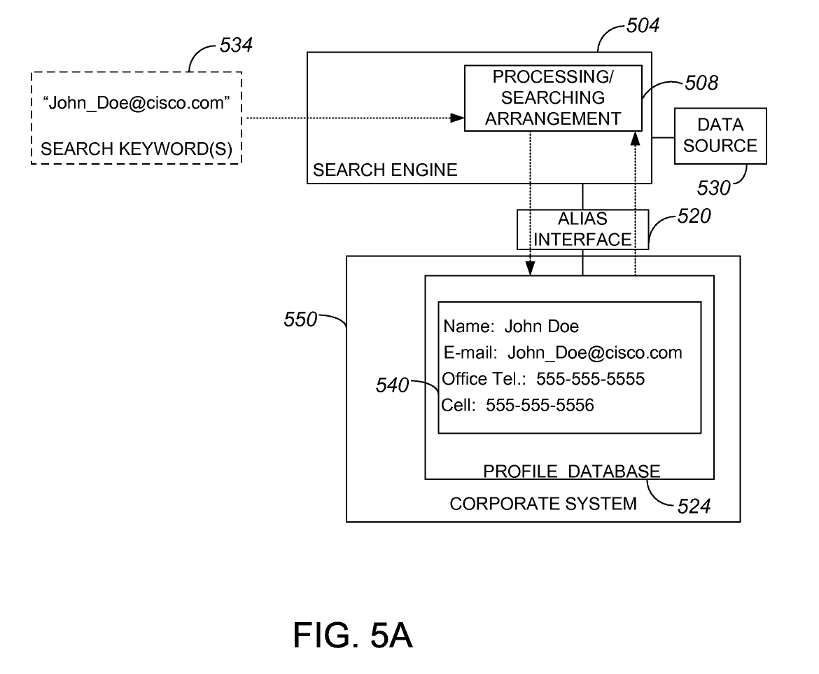

In lieu of storing associated keywords in a metadata repository of a search engine, aliases for a given search keyword may be dynamically obtained from a profile database when a search based on the search keyword is to be performed. Dynamically obtaining aliases from a profile database allows the aliases to be up-to-date, as the profile database is typically dynamic and may be updated relatively often. With reference to FIG. 5A, a system in which a search keyword is used to dynamically obtain aliases from a profile database will be described in accordance with an embodiment of the present invention. A search engine 504, which includes a processing/searching arrangement 508, obtains a search keyword 534 that is to be used to search for documents associated with a document data source 530. Search keyword 534 may generally be a string that includes any number of characters and spaces. As shown, search keyword 534 is an e-mail address, e.g., “John_Doe@cisco.com.” Search engine 504 accesses a profile database 524 of a corporate system 550 through an alias interface 520 using search keyword 534. It should be appreciated that corporate system 550 may be an intranet associated with a corporation, and that both search engine 504 and alias interface 520 may be included in corporate system 550.

When search engine 504 accesses profile database 524 via alias interface 520, access to a profile 540 associated with search keyword 534 is accessed. Profile 540 contains aliases for search keyword 534, as profile 540 contains contact information that identifies the same entity, e.g., an individual named “John Doe,” that is identified by search keyword 534. Hence, any document that is identified as including search keyword 534 or any aliases included in profile 540 refer to the same entity.

The use of alias interface 520 is such that when search keyword 534 which is “John_Doe@cisco.com” is provided to search engine 504, an actual search performed by processing/searching arrangement 508 uses more than search keyword 534 in a search. As shown in FIG. 5B, which is a diagrammatic representation of search keyword 534 and actual keywords 580 that are used in a search, an actual search performed by processing/searching arrangement 508 uses actual keywords 580 that include the name “John Doe,” office phone number “555-555-5555,” and a cell phone number “555-555-555,” in addition to the e-mail address “John_Doe@cisco.com,” to perform a search.

Actual keywords 580 that are used in a search are automatically provided to search engine 504 when search keyword 534 is provided. Hence, when a user requests a search based on search keyword 534, actual keywords 580 that are used to perform the search may be transparent to the user. In other words, the user may not necessarily be made aware of the fact that aliases are used to perform a search based on search keyword 534.

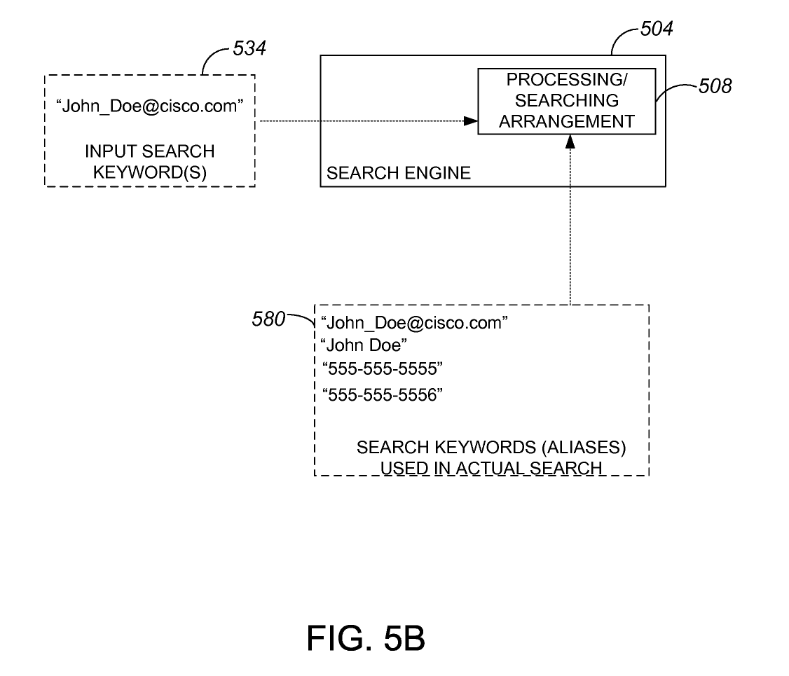

With reference to FIG. 6, one method of using aliases for a search keyword to perform a search for documents using a search engine will be described in accordance with an embodiment of the present invention. A process 600 of performing a search for documents using information in a profile database begins at step 604 in which a search keyword is obtained via a user interface. Typically, a user who intends to search a database or databases for documents or web pages will enter a search keyword via a user interface, e.g., a display page of a browser, associated with a search engine. Although a user interface has generally been described as being part of a search engine, it should be appreciated that a user interface may instead be separate from the search engine but in communication with the search engine.

Once the search keyword is obtained by the search engine, the search keyword is used as an index into a profile database in step 608. It should be appreciated that the search engine does not search for documents using the search keyword prior to indexing into a profile database. An alias interface such as alias interface 520 of FIG. 5A may provide the search engine with access to the profile database. As previously discussed, a profile database may be substantially any repository of profile or contact information. In one embodiment, a profile database may be an LDAP repository or a database that stores identifying information associated with members of an organization.

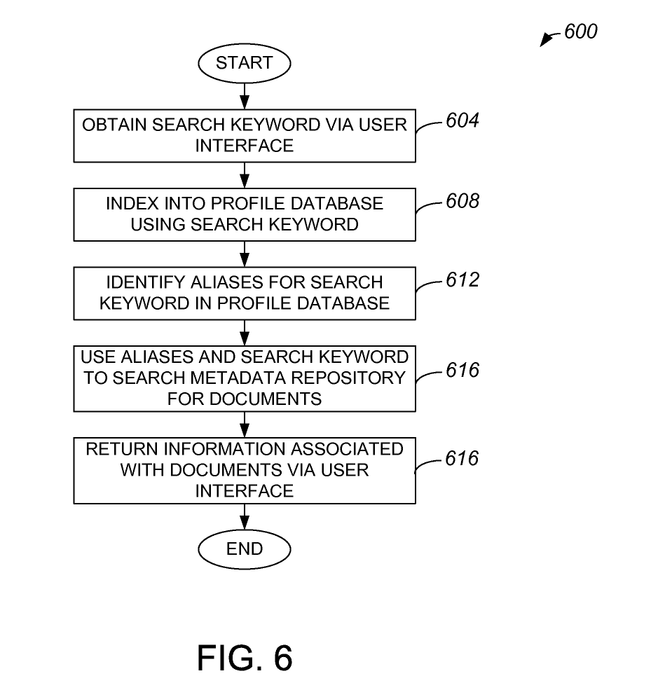

After the profile database is accessed using the search keyword, any aliases for the search keyword that are stored in the profile database are identified in step 612. One method of identifying aliases will be discussed below with reference to FIG. 7. The identified aliases are then used, in addition to the search keyword, in step 616 to search a metadata repository associated with the search engine. In other words, substantially all keywords for an entity identified by the search keyword are used to perform a search. The metadata repository is searched to identify documents which contain the search keyword, an associated alias, or both. The identified documents are typically stored in an external data source. In step 616, information associated with identified documents is returned via the user interface. Returning information associated with identified documents may include, but is not limited to, displaying links to identified documents on a display page of a browser. Upon returning information associated with identified documents, the process of performing a search for documents using information in a profile database is completed. It should be appreciated that in addition to its normal sorting algorithms, the search engine may also choose how to order the documents returned based on matches to the original search term or the number of different terms matched.

Referring next to FIG. 7, one method of identifying aliases, i.e., step 612 of FIG. 7, will be described in accordance with an embodiment of the present invention. A process 612 of identifying aliases begins at step 704 in which a profile database is searched for a profile or a record that includes a search keyword. By way of example, records in a corporate identity database may be searched for a match to a search keyword. After a search for a profile that includes the search keyword is completed, information that includes any aliases for the search keyword are identified in the profile in step 708. Once any aliases are identified, the aliases are provided to the search engine in step 712, and the process of identifying aliases is completed.

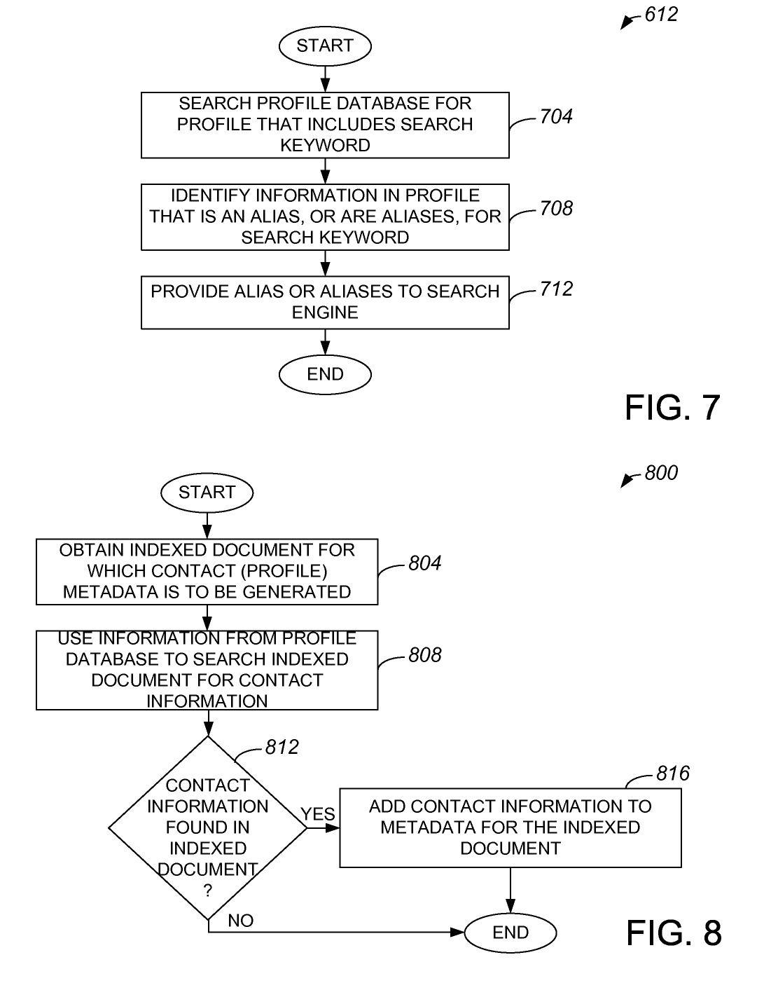

Typically, a search engine generates metadata when the search engine first becomes aware of a new document in a system, e.g., an external database, to which the search engine has access. A crawler such as crawler 212 of FIG. 2 may be used to generate metadata at predetermined time intervals. Metadata that pertains to information that is contained in a profile database may be obtained for documents by a crawler such that the documents may be searched using profile information. That is, contact metadata that corresponds to information about members of organizations may be generated to enable documents to be searched for contact information. FIG. 8 is a process flow diagram which illustrates one method of generating contact metadata in accordance with an embodiment of the present invention. A process 800 of generating contact metadata begins at step 804 in which an indexed document for which contact, or profile, metadata is to be generated is obtained. In general, an indexed document is a document for which metadata has already been stored in a metadata repository of a search engine.

Once an indexed document is obtained, information from a profile database is used to search the indexed document for contact information in step 808. For instance, contact information such as employee names, employee userids, employee telephone numbers, and employee e-mail addresses may be obtained from a profile database such that the indexed document may be searched for the contact information. A determination is made in step 812 as to whether contact information is found in the indexed document.

It should be appreciated that a determination of whether contact information is found in an indexed document may utilize heuristic algorithms such that perceived contact information which is, in reality, not contact information may be filtered out from being identified as contact information. That is, heuristics may be used to filter out false positives. By way of example, if a name or userid is a dictionary word that appears often in an indexed document, the instances of the name or userid are likely not to constitute contact information. Hence, a heuristic algorithm that accounts for dictionary words and frequent occurrences of dictionary words may be incorporated into a determination of whether contact information is found in an indexed document.

If the determination in step 812 is that no contact information is found in the indexed document, the process of generating contact metadata is terminated. Alternatively, if it is determined in step 812 that contact information is found in the indexed document, then process flow moves to step 816 in which the contact information found in the indexed document is added to the metadata for the indexed document. After the contact information found in the indexed document is added to the metadata for the indexed document, the process of generating contact metadata is completed.

Although only a few embodiments of the present invention have been described, it should be understood that the present invention may be embodied in many other specific forms without departing from the spirit or the scope of the present invention. By way of example, aliases have been described as being obtained from a profile database. However, aliases may be obtained from more than one profile database. That is, when aliases are being obtained, an alias interface may allow a search engine access to a plurality of different profile databases. Such aliases may also include common contact information, such as substituting the name “Bill” for the name “William”.

A profile database has been described as being a repository that includes identifiers associated with a member of an organization such as an employee of a corporation. For instance, as profile database has been described as including a record that contains an employee name, an employee e-mail address, employee telephone numbers, and other information that identifies the employee. It should be appreciated, however, that the generation of aliases or a set of keywords from one keyword is not limited to a profile database. Aliases may also be generated from repositories including, but not limited to, address books and telephone books, or substantially any repository or application which stores contact information associated with individuals. Alternatively, aliases may be generated from repositories which store contact information for organizations rather than individuals, e.g., a repository may store names of organizations and general e-mail addresses or telephone numbers for the organization.

A search engine may generally be incorporated as a part of an overall computing system, e.g., a search engine may be implemented as code devices or logic that executes on an overall computing system. It should be appreciated, however, that a search engine may be implemented in a variety of different forms without departing from the spirit or the scope of the present invention.

An alias interface, as described above, may be a module that is interfaced with a search engine to enable the search engine to access a profile database. Alternatively, however, an alias interface may be a part of search engine, i.e., a component within the search engine. Regardless of whether an alias interface is interfaced with a search engine or is a part of the search engine, the alias interface may be considered to be part of an overall search engine arrangement. That is, a search engine and an alias interface may be an overall search engine arrangement.

Various features may be implemented to enhance the quality of the results provided by a search engine which utilizes an alias interface. By way of example, a feature that allows metadata to be disambiguated may be incorporated. Such a feature may enable the search engine to provide the ability for a user to ascertain which of two entities with the same keyword is the actual desired entity.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method comprising:
obtaining a search keyword via a user interface;
automatically determining if there is at least one alias for the search keyword by searching a first database using the search keyword, the first database being a profile database that is configured to include a plurality of profiles that contain contact information, the plurality of profiles including a first profile that contains the search keyword;
automatically identifying the at least one alias for the search keyword if it is determined that there is the at least one alias for the search keyword, wherein automatically identifying the at least one alias for the search keyword includes accessing the first profile; and,
automatically searching for at least one document using the search keyword and the at least one alias if the at least one alias is identified, the at least one document being associated with a first data source, the first data source being a document data source.

2. The method of claim 1 wherein the at least one alias is identified from the contact information.

3. The method of claim 2 wherein the profile database is a light weight directory access protocol (LDAP) repository.

4. The method of claim 3 wherein the contact information is identifying information associated with at least one member of an organization.

5. The method of claim 4 wherein the contract information includes at least one selected from the group including an e-mail address, a telephone number, and a name of the at least one member of the organization.

6. The method of claim 2 wherein if it is determined that there is not the at least one alias for the search keyword, the method includes:
automatically searching for the at least one document using the search keyword.

7. An apparatus comprising:
means for obtaining a search keyword via a user interface;
means for automatically determining if there is at least one alias for the search keyword by searching a first database using the search keyword, the first database being a profile database that is configured to include a plurality of profiles that contain contact information, the plurality of profiles including a first profile that contains the search keyword;
means for automatically identifying the at least one alias for the search keyword if it is determined that there is the at least one alias for the search keyword, wherein the means for automatically identifying the at least one alias for the search keyword include means for accessing the first profile; and,
means for automatically searching for at least one document using the search keyword and the at least one alias if the at least one alias is identified, the at least one document being associated with a first data source, the first data source being a document data source.

8. Logic encoded in one or more tangible media for execution and when executed operable to:
obtain a search keyword via a user interface;
automatically determine if there is at least one alias for the search keyword by searching a first database using the search keyword, the first database being a profile database that is configured to include a plurality of profiles that contain contact information, the plurality of profiles including a first profile that contains the search keyword;
automatically identify the at least one alias for the search keyword if it is determined that there is the at least one alias for the search keyword, wherein the logic operable to automatically identify the at least one alias for the search keyword is further operable to access the first profile; and,
automatically search for at least one document using the search keyword and the at least one alias if the at least one alias is identified, the at least one document being associated with a first data source, the first data source being a document data source.

9. The logic of claim 8 wherein the at least one alias is identified from the contact information.

10. The logic of claim 9 wherein the profile database is a light weight directory access protocol (LDAP) repository.

11. The logic of claim 10 wherein the contact information is identifying information associated with at least one member of an organization.

12. The logic of claim 11 wherein the contract information includes at least one selected from the group including an e-mail address, a telephone number, and a name of the at least one member of the organization.

13. The logic of claim 9 wherein if it is determined that there is not the at least one alias for the search keyword, the logic is further operable to automatically search for the at least one document using the search keyword.

14. A system comprising:
a searching arrangement;
a user interface, the user interface being arranged to obtain a search keyword and to provide the search keyword to the searching arrangement; and
an alias interface, the alias interface being arranged to enable the searching arrangement to access a database to identify at least one alias associated with the search keyword, wherein the searching arrangement is arranged to use the search keyword and the at least one alias to perform a search of a plurality of documents associated with a data source.

15. The system of claim 14 wherein the database contains contact information and the at least one alias is contact information associated with the search keyword.

16. The system of claim 14 wherein the searching arrangement is arranged to identify a first document of the plurality of documents as including at least one selected from the group including the search keyword and the at least one alias.

17. The system of claim 16 further including:
a metadata repository, the metadata repository being arranged to store information associated with the plurality of documents associated with the data source, wherein the searching arrangement is arranged to search the information using the search keyword and the at least one alias to identify the first document.
